(19) United States
(12) Patent Application Publication
(10) Pub. No.: US 2001/0055972 A1
(43) Pub. Date: Dec. 27, 2001

(54) Radio communication system and base stations and mobile stations in the system

(76) Inventor: Masayuki Sakata, Tokyo (JP)

Correspondence Address: SUGHRUE, MION, ZINN, MACPEAK & SEAS, 2100 Pennsylvania Avenue, N.W., Washington, DC, 20037, US

(21) Appl. No.: 09/880,048

(22) Filed: Jun. 14, 2001

(30) Foreign Application Priority Data
Jun. 15, 2000 (JP) 180212/2000

(51) Int. Cl. H04Q 7/20

(52) U.S. Cl. 455/452; 455/511; 455/450

(57) ABSTRACT

A radio communication system, in which the number of radio channels using between a base station and a mobile station is increased or decreased and non-voice data are transmitted and received efficiently, is provided. The radio communication system provides a controller for controlling the number of the radio channels. The controller provides a measuring means for measuring the amount of data storing in buffer storage in the base station or in buffer storage in the mobile station, and a comparing means for comparing the data measured at the measuring means with a first threshold value and a second threshold value. The controller further provides an increasing/decreasing means for increasing the number of the radio channels when the data storing in the buffer storage in the base station or in the buffer storage in the mobile station is more than the first threshold value, and for decreasing the number of the radio channels when the data storing in the buffer storage in the base station or in the buffer storage in the mobile station is less than the second threshold value based on the compared result at the comparing means.

### BACKGROUND OF THE INVENTION

The present invention relates to a radio communication system, and base stations and mobile stations in the system, in particular, in which data are transmitted and received through plural radio channels.

### DESCRIPTION OF THE RELATED ART

At a radio communication system, when data are transmitted and received between a mobile station such as, a cellular phone and a personal handy-phone system (PHS), and a base station, a standard is used. And a standard, with which data, except voice data that require real time communication, are transmitted and received by using plural radio channels, is described in the TIA/EIA/IS-707-A (Data Service Options for Spread Spectrum Systems 00/APR/99). Hereinafter, the data except the voice data are referred to as non-voice data.

In the above mentioned standard, according to the TIA/EIA/IS-707A.8: Radio Link Protocol Type 2, as forward traffic channels and reverse traffic channels, eight channels, in which data are transmitted at a rate of 9.6 Kbps or 14.4 Kbps, can be used as maximum respectively. For example, a base station attaches a Radio Link Protocol (RLP) to the header part of non-voice data and transmits the non-voice data by allocating the non-voice data to plural reverse traffic channels in order, and a mobile station puts the received non-voice data together corresponding to the RLP of the header part.

With this, the non-voice data can be transmitted and received for a short transmission time, compared with the communication, in which the data are transmitted and received by using one forward traffic channel (radio channel) and one reverse traffic channel (radio channel) at the RLP Type 1 of the TIA/EIA/IS-707A. Further, before various data are transmitted and received between the base station and the mobile station, the number of radio channels using between them is decided, and the various data are transmitted and received by using the decided number of the radio channels.

However, at the conventional technology, as mentioned above, before various data are transmitted and received between the base station and the mobile station, the number of radio channels using between them is decided, and the various data are transmitted and received by using the decided number of the radio channels. And during the communication, the number of the using radio channels is not increased or decreased corresponding to the amount of the non-voice data.

Consequently, at a case that the amount of data to be transmitted is large, the data are not transmitted for a designated transmission time, and at a case that the amount of data to be transmitted is small, the number of keeping radio channels is not used efficiently, and some radio channels become unnecessary. In this case, the number of radio channels, which can be used between the base station and the other mobile stations, is decreased, and the data transmission in the radio communication system can not be executed efficiently.

### SUMMARY OF THE INVENTION

It is therefore an object of the present invention to provide a radio communication system, and base stations and mobile stations in the system, in which the number of radio channels using between a base station and a mobile station can be increased or decreased during the communication and non-voice data can be transmitted and received efficiently.

According to a first aspect of the present invention for achieving the object mentioned above, there is provided a radio communication system. The radio communication system provides plural base stations, plural mobile stations, and plural controllers for controlling the number of radio channels, wherein. The base station provides a first deciding means for deciding the number of reverse traffic channels being radio channels that is used when the base station transmits data to the mobile station, first buffer storage for storing the data temporarily, and a first data transmitting means for transmitting the data storing in the first buffer storage to the mobile station by using the number of the reverse traffic channels decided at the first deciding means. And the mobile station provides a second deciding means for deciding the number of forward traffic channels being radio channels that is used when the mobile station transmits data to the base station, second buffer storage for storing the data temporarily, and a second data transmitting means for transmitting the data storing in the second buffer storage to the base station by using the number of the forward traffic channels decided at the second deciding means. And the controller provides a first measuring means for measuring the amount of the data storing in the first buffer storage, a second measuring means for measuring the amount of the data storing in the second buffer storage, a first comparing means for comparing the amount of the data measured at the first measuring means with a first threshold value and a second threshold value, a second comparing means for comparing the amount of the data measured at the second measuring means with the first threshold value and the second threshold value, a first increasing/decreasing means for increasing the number of the reverse traffic channels when the amount of the data storing in the first buffer storage is more than the first threshold value and for decreasing the number of the reverse traffic channels when the amount of the data storing in the first buffer storage is less than the second threshold value based on the compared result at the first comparing means, and a second increasing/decreasing means for increasing the number of the forward traffic channels when the amount of the data storing in the second buffer storage is more than the first threshold value and for decreasing the number of the forward traffic channels when the amount of the data storing in the second buffer storage is less than the second threshold value based on the compared result at the second comparing means.

According to a second aspect of the present invention, in the first aspect, the controller further provides a timer for setting timing of measuring the amount of the data storing in the first buffer storage or in the second buffer storage by the first measuring means or the second measuring means.

According to a third aspect of the present invention, in the first aspect, the controller is built in the mobile station or the base station.

According to a fourth aspect of the present invention, in the first aspect, one number of the reverse traffic channels is increased every when the amount of the data storing in the first buffer storage exceeds one first threshold value, and one number of the forward traffic channels is increased every when the amount of the data storing in the second buffer storage exceeds one first threshold value.

According to a fifth aspect of the present invention, in the first aspect, the number of the reverse traffic channels or the forward traffic channels is decreased by half or to one third, or to one fourth, and when the number of the reverse traffic channels or the forward traffic channels was decreased too many, the number is increased again.

According to a sixth aspect of the present invention, in the first aspect, the number of the radio channels including the increased number of the radio channels by the first or second increasing/decreasing means does not exceed the maximum number of the reverse traffic channels or the forward traffic channels that was confirmed to be able to use between the base station and the mobile station each other at the time when communication was started.

According to a seventh aspect of the present invention, there is provided a base station in a radio communication system. The base station provides a deciding means for deciding the number of radio channels that is used when the base station transmits data to a mobile station, buffer storage for storing the data temporarily, a data transmitting means for transmitting the data storing in the buffer storage to the mobile station by using the number of the radio channels decided at the deciding means, and a controller for controlling the number of the radio channels. And the controller provides a measuring means for measuring the amount of the data storing in the buffer storage, a comparing means for comparing the amount of the data measured at the measuring means with a first threshold value and a second threshold value, and an increasing/decreasing means for increasing the number of the radio channels when the amount of the data storing in the buffer storage is more than the first threshold value and for decreasing the number of the radio channels when the amount of the data storing in the buffer storage is less than the second threshold value based on the compared result at the comparing means.

According to an eighth aspect of the present invention, there is provided a mobile station in a radio communication system. The mobile station provides a deciding means for deciding the number of radio channels that is used when the mobile station transmits data to a base station, buffer storage for storing the data temporarily, a data transmitting means for transmitting the data storing in the buffer storage to the base station by using the number of the radio channels decided at the deciding means, and a controller for controlling the number of the radio channels. And the controller provides a measuring means for measuring the amount of the data storing in the buffer storage, a comparing means for comparing the amount of the data measured at the measuring means with a first threshold value and a second threshold value, and an increasing/decreasing means for increasing the number of the radio channels when the amount of the data storing in the buffer storage is more than the first threshold value and for decreasing the number of the radio channels when the amount of the data storing in the buffer storage is less than the second threshold value based on the compared result at the comparing means.

### BRIEF DESCRIPTION OF THE DRAWINGS

The objects and features of the present invention will become more apparent from the consideration of the following detailed description taken in conjunction with the accompanying drawings in which:

FIG. 1 is a block diagram showing a basic structure of an embodiment of a radio communication system of the present invention;

FIG. 2 is a block diagram showing internal structures of a BS, an MS, and a controller shown in FIG. 1 at the embodiment of the radio communication system of the present invention;

FIG. 3 is a flowchart showing the operation increasing the number of radio channels at the embodiment of the radio communication system of the present invention; and

FIG. 4 is a flowchart showing the operation decreasing the number of radio channels at the embodiment of the radio communication system of the present invention.

### DESCRIPTION OF THE PREFERRED EMBODIMENT

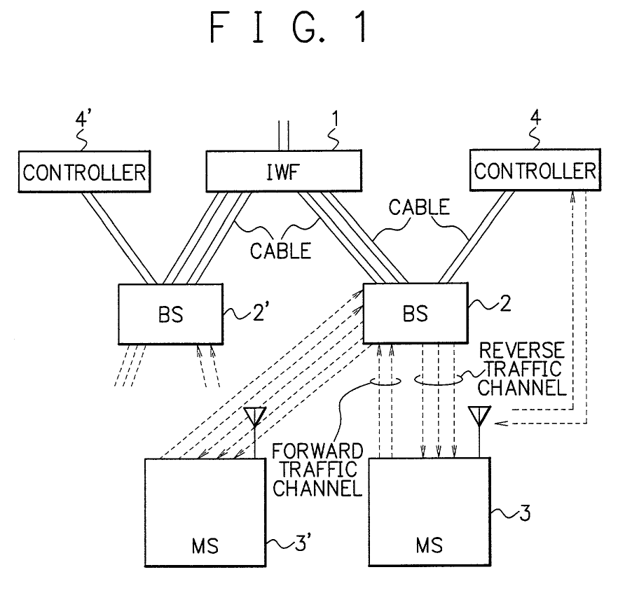

Referring now to the drawings, an embodiment of the present invention is explained in detail. FIG. 1 is a block diagram showing a basic structure of an embodiment of a radio communication system of the present invention. As shown in FIG. 1, the embodiment of the radio communication system of the present invention consists of an inter working function (IWF) 1, two base stations (BS) 2 and 2′, two mobile stations (MS) 3 and 3′, and two controllers 4, and 4′. Actually, more than two BSs, MSs, and controllers exist in the radio communication system, however, in order to make the explanation concise, the numbers of the BSs, MSs, and controllers are limited to two each.

The IWF 1 is connected to a frame relay network (not shown) or a switched multi-megabit data service (SMDS) network (not shown). And the IWF 1 and the BSs 2 and 2′ are connected through two cables such as optical fibers, and one of the two cables is used as transmitting and receiving non-voice data, and the other cable is used as transmitting and receiving a control signal. Further the BS 2 is connected to the controller 4 through a cable such as an optical fiber and the BS 2′ is connected to the controller 4′ through a cable such as an optical fiber. Moreover, the BS 2 is connected to the MS 3 through, for example, three reverse traffic channels and two forward traffic channels. Further the MS 3 is connected to the controller 4 through two radio channels, and also the MS 3′ is connected to the controller 4′ through two radio channels. In this, the present invention is for transmitting and receiving the non-voice data, therefore, the explanation about voice data is omitted.

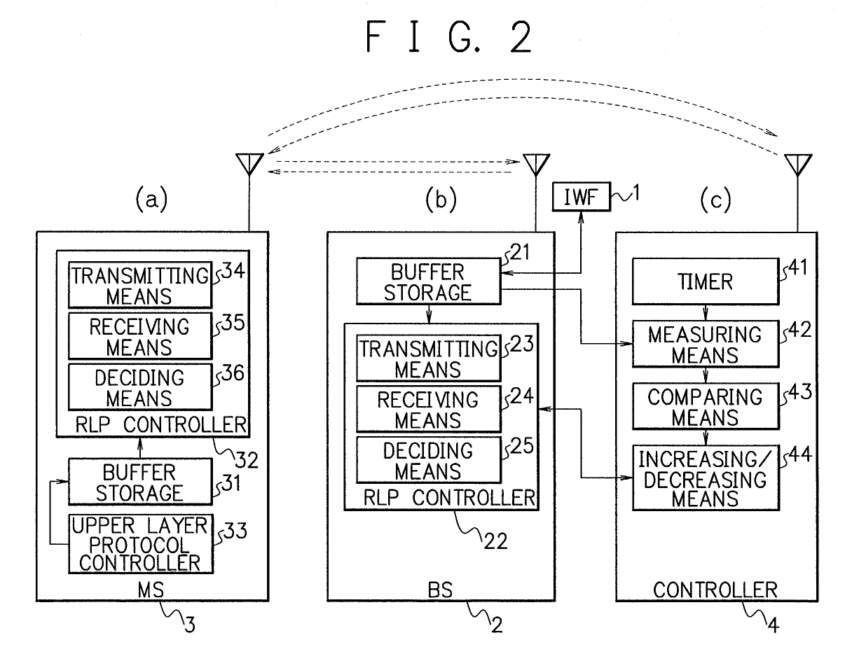

FIG. 2 is a block diagram showing internal structures of the BS 2, the MS 3, and the controller 4 shown in FIG. 1 at the embodiment of the radio communication system of the present invention. As shown in FIG. 2(a), the MS 3 consists of a buffer storage 31, an RLP controller 32, and an upper layer protocol controller 33. The RLP controller 32 consists of a receiving means 35 that receives non-voice data transmitted from the BS 2 and the maximum number of the forward traffic channels, which is judged to be able to use at the BS 2, a deciding means 36 that decides the actually using number of the forward traffic channels based on the received maximum usable number of the forward traffic channels and the processing ability of data at the MS 3, and a transmitting means 34 that transmits the non-voice data and the decided number of the forward traffic channels to the BS 2. The buffer storage 31 temporarily stores the non-voice data to be transmitted from the transmitting means 34. The upper layer protocol controller 33 controls a point to point protocol (PPP) and the other upper layer protocols.

As shown in FIG. 2(b), the BS 2 consists of a buffer storage 21, and an RLP controller 22. The RLP controller 22 consists of a receiving means 24 that receives non-voice data transmitted from the IWF 1 and the maximum number of the reverse traffic channels, which is judged to be able to use at the MS 3, a deciding means 25 that decides the actually using number of the reverse traffic channels based on the received maximum usable number of the reverse traffic channels and the using state of surrounding radio channels, and a transmitting means 23 that transmits the non-voice data and the decided number of the reverse traffic channels to the MS 3. The buffer storage 21 temporarily stores the non-voice data transmitted from the IWF 1 before transmitting the non-voice data to the MS 3, and adjusts the timing to transmit the non-voice data to the MS 3.

As shown in FIG. 2(c), the controller 4 consists of a timer 41, a measuring means 42, a comparing means 43, and an increasing/decreasing means 44. The measuring means 42 measures the amount of data storing in the buffer storage 21 and 31 via a wire channel or a radio channel based on the timing from the timer 41. The comparing means 43 compares the measured amount of data storing in the buffer storage 21 and 31 with a first threshold value and a second threshold value. The increasing/decreasing means 44 increases or decreases the number of radio channels based on the compared result at the comparing means 43.

The IWF 1 switches over from a BS, which transmits and receives data to and from an MS, to some other BS, and outputs non-voice data transmitted from such as a telephone (not shown) to the BS that is connected to the MS through a cable.

And when a transport control protocol (TCP) is used, there is a case that several data are gathered and transmitted together depending on the window sizes, in this case, the data are always outputted to the buffer storage 21 or 31, therefore, the data are stored in the buffer storage 21 and 31.

Next, referring to FIGS. 1 and 2, the basic operation of the embodiment of the radio communication system of the present invention is explained. For example, at the case that data transmitted from the BS 2′ are transmitted to the MS 3 via the IWF 1, the IWF 1, received the data, outputs a control signal, which makes the BS 2 decide the number of radio channels between the BS 2 and the MS 3, to the BS 2 via a cable. The BS 2, received the control signal, judges what is the maximum number of the reverse traffic channels that can be used at the BS 2. And the transmitting means 23 in the BS 2 transmits the judged maximum number of the reverse traffic channels to the MS 3. The receiving means 35 in the MS 3 receives the maximum usable number of the reverse traffic channels.

The MS 3, received the maximum number of the reverse traffic channels, judges what is the maximum number of forward traffic channels that can be used at the MS 3. And the transmitting means 34 in the MS 3 transmits the judged maximum usable number of the forward traffic channels to the BS 2. The receiving means 24 in the BS 2 receives the maximum usable number of the forward traffic channels.

The maximum usable number of the radio channels, received at the receiving means 24, is inputted to the deciding means 25. And the maximum usable number of the radio channels, received at the receiving means 35, is inputted to the deciding means 36. The deciding means 25 decides the number of the reverse traffic channels that are used actually, based on the inputted maximum number of the reverse traffic channels and the using state of radio channels of the MS 3 connecting to the BS 2. And deciding means 36 decides the number of the forward traffic channels that are used actually, based on the inputted maximum number of the forward traffic channels and the processing ability of data at the MS 3. The transmitting means 23 transmits the decided number of the reverse traffic channels to the MS 3. And the receiving means 35 in the MS 3 receives the transmitted number of the reverse traffic channels.

After this, the radio channels between the BS 2 and the MS 3 are actually established. And also the transmitting means 23 in the BS 2 informs the IWF 1 about the decided number of the forward traffic channels and the decided number of the reverse traffic channels. The IWF 1, received this information, transmits data to the BS 2 via a cable. The BS 2 receives the transmitted data and makes the buffer storage 21 store the data temporarily.

And then, the transmission timing is adjusted and the data storing in the buffer storage 21 are extracted, and it is added that the data is the RLP to the header part of the data, and the data are transmitted to the MS 3 via the established reverse traffic channels.

In this, when the amount of non-voice data that are transmitted from the IWF 1 is larger than the amount of data that are transmitted from the BS 2 to the MS 3, and at a case that the data are needed to transmit again caused by that some error of the transmission of the data from the BS 2 to the MS 3 occurs, the amount of the data that are stored in the buffer storage 21 increase, and this causes some delay of the transmission of data.

In order to avoid this, it must be studied that the amount of the data that can be transmitted from the BS 2 to the MS 3 is made to be larger by increasing the number of the reverse traffic channels. For example, when the number of using radio channels between the BS 2 and some other MS connecting to the BS 2 is decreased, that is, when the using state of the radio channels between the BS 2 and the some other MS changes, the number of radio channels between the BS 2 and the MS 3 can be increased.

On the contrary, when the amount of non-voice data that are transmitted from the IWF 1 is smaller than the amount of data that can be transmitted from the BS 2 to the MS 3, the non-voice data are transmitted immediately when the transmission timing is set. Therefore, the data are not almost stored in the buffer storage 21 and transmitted to the MS 3 from the BS 2 at an almost thorough state. Further, unnecessary radio channels that are not used actually for the transmission of the data occurs. In this case, the number of the radio channels, which can be used between the BS 2 and the other MSs, decreases by that the unnecessary radio channels are kept by the BS 2 and the MS 3. Consequently, the data are not transmitted efficiently between the BS 2 and the other MSs.

As mentioned above, when the data are transmitted and received between the BS 2 and the MS 3 by using the number of radio channels decided once, on the one hand, it occurs that the necessary number of the radio channels can not be kept, and on the other hand, it occurs that the unnecessary number of the radio channels is kept.

In order to solve this problem, at the embodiment of radio communication system of the present invention, in the controller 4, the measuring means 42 periodically measures the amount of the data storing in the buffer storage 21 and 31 by using the timer 41. And the comparing means 43 compares the measured amount of the data with threshold values, and the increasing/decreasing means 44 increases or decreases the number of the radio channels based on the compared results. Therefore, the non-voice data between the BS 2 and the MS 3/the other MSs can be transmitted efficiently.

At the basic operation of the embodiment of the radio communication system of the present invention, the case that the data are transmitted from the IWF 1 to the MS 3 was explained, however, this basic operation can be applied to the case that the data are transmitted from the MS 3 to the IWF 1. That is, the number of the forward traffic channels are decided by the transmitting means 34 and 23, the receiving means 35 and 24, and the deciding means 36, and the data are transmitted by using these decided and established radio channels.

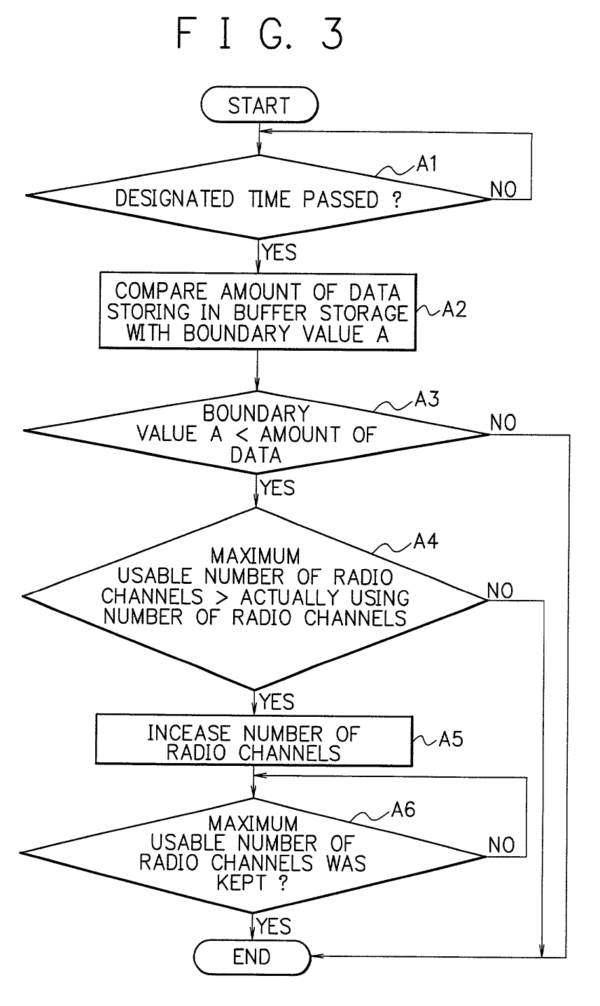

Next, referring to drawings, the operation increasing the number of radio channels (forward traffic channels and reverse traffic channels) is explained. FIG. 3 is a flowchart showing the operation increasing the number of radio channels at the embodiment of the radio communication system of the present invention. As mentioned above, the number of the radio channels is decided and the radio channels are actually established between the BS2 and the MS 3. And data transmitted from the IWF 1 are temporarily stored in the buffer storage 21 in the BS 2, and after adjusting the transmission timing, the data are started to transmit from the BS 2 to the MS 3.

Referring to FIGS. 2 and 3, the operation increasing the number of radio channels at the embodiment of the radio communication system of the present invention is explained in detail.

First, the operation increasing reverse traffic channels is explained. When data are started to transmit, the timer 41 in the controller 4 is made to be on, and the timer 41 outputs a signal to the measuring means 42 every a designated time, for example, every 5 seconds, or 10 seconds.

When the measuring means 42 receives the signal from the timer 41, the measuring means 42 judges that the designated time passed (YES at step A1), and measures the amount of data storing in the buffer storage 21 by making this judgement as a trigger. The comparing means 43 compares the amount of the data storing in the buffer storage 21 with a boundary value A (threshold value) (step A2).

At the case that the amount of the data storing in the buffer storage 21 is equal to or less than the boundary value A (NO at step A3), the operation increasing the number of the reverse traffic channels ends. At the case that the amount of the data storing in the buffer storage 21 is more than the boundary value A (YES at the step A3), the increasing/decreasing means 44 confirms again what is the maximum number of the reverse traffic channels that can be used at the MS 3 for the MS 3.

At the case that the actually using number of the reverse traffic channels is less than the maximum number of the reverse traffic channels confirmed at the increasing/decreasing means 44 (YES at step A4), the increasing/decreasing means 44 confirms the using state of the reverse traffic channels between the BS 2 and the other MSs, for example, by investigating the number of vacant channels. And at the case that the number of the reverse traffic channels using between the BS 2 and the other MSs is small, and the number of the reverse traffic channels between the BS 2 and the MS 3 can be increased, the number of the reverse traffic channels is increased (step A5). At the case that the actually using number of the reverse traffic channels is equal to the maximum number of the reverse traffic channels (NO at the step A4), the operation increasing the reverse traffic channels ends.

At the step A5, the increasing/decreasing means 44 decides the adding number of the reverse traffic channels within the maximum number of the reverse traffic channels that can be used at the MS 3, corresponding to the amount of the data storing in the buffer storage 21. For example, based on the standard stipulated in the TIA/EIA/IS-707-A, newly adding reverse traffic channels are kept, and the number of the reverse traffic channels is increased.

At the step A2, the boundary value A using at the comparison with the amount of data storing in the buffer storage 21 is set to be, for example, 5 Kbytes, at the case that the RLP type 2 is used and the multiplex option is 1, 3, 5, 7, 9, 11, 13, and 15 (for example, when the data transmission rate is 9.6 Kbytes) per one channel of radio channels, since the maximum transmission amount of data is 20 bytes/20 ms=5 Kbytes/5 s. Therefore, at the case that the amount of the data storing in the buffer storage 21 is more than 5 Kbytes, one reverse traffic channel is added, and at the case that the amount of the data storing in the buffer storage 21 is more than 10 Kbytes, two reverse traffic channels are added. That is, one reverse traffic channel is added every 5 Kbytes within the maximum and usable number of the reverse traffic channels.

And also the boundary value A can be set to be 8 Kbytes, at the case that the RLP type 2 is used and the multiplex option is 2, 4, 6, 8, 10, 12, 14, and 16 (for example, when the data transmission rate is 14.4 Kbytes) per one channel of radio channels, since the maximum transmission amount of data is 32 bytes/20 ms=8 Kbytes/5 s. Therefore, at the case that the amount of the data storing in the buffer storage 21 is more than 8 Kbytes, one reverse traffic channel is added, and at the case that the amount of the data storing in the buffer storage 21 is more than 16 Kbytes, two reverse traffic channels are added. That is, one reverse traffic channel is added every 8 Kbytes within the maximum and usable number of the reverse traffic channels.

And the increasing/decreasing means 44 confirms whether the maximum usable number of the reverse traffic channels for the MS 3 was kept or not, and when this was confirmed (YES at step A6), the operation increasing the reverse traffic channels ends. When the end of the operation increasing the reverse traffic channels was confirmed, the added number of the reverse traffic channels is also used for transmitting the data. As mentioned above, the number of the reverse traffic channels from the BS 2 to the MS 3 was increased, and the amount of the data storing in the buffer storage 21 was decreased, therefore, delaying transmission of the data can be avoided.

Next, referring to FIGS. 2 and 3, the operation increasing forward traffic channels is explained. As mentioned above, first, the number of the radio channels is decided, and after this, the radio channels are actually established. And data from the upper layer protocol controller 33 are temporarily stored in the buffer storage 31 of the MS 3. After that the transmission timing is adjusted, the data are started to transmit from the MS 3, and the timer 41 in the controller 4 is made to be on, and the timer outputs a signal every a designated time.

When the measuring means 42 receives the signal from the timer 41, the measuring means 42 judges that the designated time passed (YES at step A1). The measuring means 42 measures the amount of data storing in the buffer storage 31 by making this judgement as a trigger. And the comparing means 43 compares the amount of the data storing in the buffer storage 31 with a boundary value A (threshold value) (step A2).

At the case that the amount of the data storing in the buffer storage 31 is equal to or less than the boundary value A (NO at step A3), the operation increasing the number of the forward traffic channels ends. At the case that the amount of the data storing in the buffer storage 31 is more than the boundary value A (YES at the step A3), the increasing/decreasing means 44 confirms again what is the maximum number of the forward traffic channels that can be used at the BS 2 for the BS 2.

At the case that the actually using number of the forward traffic channels is less than the maximum number of the forward traffic channels confirmed at the increasing/decreasing means 44 (YES at step A4), the increasing/decreasing means 44 decides the adding number of the forward traffic channels within the maximum number of the forward traffic channels that can be used at the MS 3. For example, based on the TIA/EIA/IS-707-A standard, the newly adding number of the forward traffic channels is kept, and the number of the forward traffic channels is decided and increased (step A5). In this, the boundary value A using at the step A2 for comparing with the amount of the data storing in the buffer storage 31 is the same at the operation increasing the reverse traffic channels.

At the case that the actually using number of the forward traffic channels is equal to the maximum number of the forward traffic channels (NO at the step A4), the operation increasing the forward traffic channels ends.

And the increasing/decreasing means 44 confirms whether the maximum usable number of the forward traffic channels for the BS 2 was kept or not, and when this was confirmed (YES at step A6), the operation increasing the forward traffic channels ends. When the end of the operation increasing the forward traffic channels was confirmed, the added number of the forward traffic channels is also used for transmitting the data. As mentioned above, the number of the forward traffic channels from the MS 3 to the BS 2 was increased, and the amount of the data storing in the buffer storage 31 was decreased, therefore, delaying transmission of the data can be avoided.

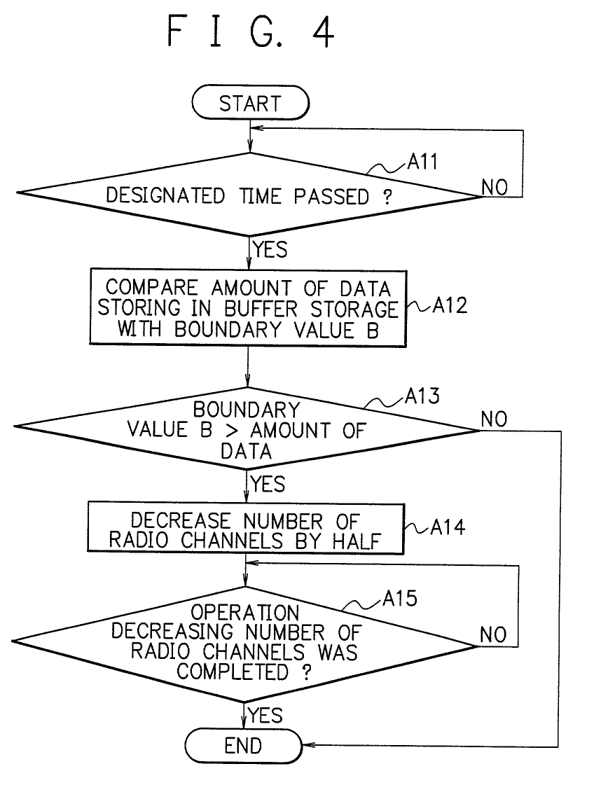

Next, referring to drawings, the operation decreasing the number of radio channels (forward traffic channels and reverse traffic channels) is explained. FIG. 4 is a flowchart showing the operation decreasing the number of radio channels at the embodiment of the radio communication system of the present invention. As mentioned above, first, the number of the radio channels is decided and the radio channels are actually established between the BS 2 and the MS 3. And the data transmitted from the IWF 1 are temporarily stored in the buffer storage 21 in the BS 2, and after adjusting the transmission timing, the data are started to transmit from the BS 2 to the MS 3.

Referring to FIGS. 2 and 4, the operation decreasing the number of radio channels at the embodiment of the radio communication system of the present invention is explained in detail.

First, the operation decreasing reverse traffic channels is explained. When the data are started to transmit, the timer 41 in the controller 4 is made to be on, and the timer 41 outputs a signal to the measuring means 42 every a designated time, for example, every 5 seconds, or 10 seconds.

When the measuring means 42 receives the signal from the timer 41, the measuring means 42 judges that the designated time passed (YES at step A11). The measuring means 42 measures the amount of data storing in the buffer storage 21 by making this judgement as a trigger, and the comparing means 43 compares the amount of the data storing in the buffer storage 21 with a boundary value B (threshold value) (step A12).

At the case that the amount of the data storing in the buffer storage 21 is less than the boundary value B (YES at step A13), it is judged that unnecessary reverse traffic channels exist, and the increasing/decreasing means 44 decreases the number of the reverse traffic channels that is actually established, for example, by half, based on the TIA/EIA/IS-707-A standard (step A14). In this, the boundary value B using at the step A12, which is used to compare with the amount of the data storing in the buffer storage 21, is set to be a very small value, for example, a few Kbytes.

And the increasing/decreasing means 44 confirms whether the operation decreasing the number of the reverse traffic channels was completed or not, and when this was confirmed (YES at step A15), the operation decreasing the number of the reverse traffic channels ends. Actually, at the case that the number of the reverse traffic channels was decreased too many, the number of the reverse traffic channels is adjusted by applying the operation increasing the number of the reverse traffic channels.

When the end of the operation decreasing the reverse traffic channels was confirmed, the decreased and remaining number of the reverse traffic channels is used for transmitting the data. As mentioned above, the number of the reverse traffic channels from the BS 2 to the MS 3 was decreased, therefore, the number of the reverse traffic channels being usable between the BS 2 and the other MSs was increased. Therefore, the transmission efficiency between the BS 2 and the other MSs can be made to be high.

At this operation decreasing the number of the reverse traffic channels, when the amount of the data storing in the buffer storage 21 is less than the boundary value B, the case that the existing number of the reverse traffic channels was decreased by half was explained. However, the number of the reverse traffic channels can be decreased to one third or one fourth of the original number of the reverse traffic channels.

Next, referring to FIGS. 2 and 4, the operation decreasing forward traffic channels is explained. First, the number of the radio channels is decided and the decided radio channels are actually established between the BS 2 and the MS 3. And data from the upper layer protocol controller 33 are temporarily stored in the buffer storage 31 in the MS 3, and after adjusting the transmission timing, the data are started to transmit from the MS 3 to the BS 2.

When the data are started to transmit, the timer 41 in the controller 4 is made to be on, and the timer 41 outputs a signal to the measuring means 42 every a designated time, for example, every 5 seconds, or 10 seconds.

When the measuring means 42 judges that the designated time passed by receiving the signal from the timer 41 (YES at step A11). The measuring means 42 measures the amount of data storing in the buffer storage 31 by making this judgement as a trigger, and the comparing means 43 compares the amount of the data storing in the buffer storage 31 with a boundary value B (threshold value) (step A12).

At the case that the amount of the data storing in the buffer storage 31 is less than the boundary value B (YES at step A13), it is judged that unnecessary forward traffic channels exist, and the increasing/decreasing means 44 decreases the number of the forward traffic channels that is actually established, for example, by half, based on the TIA/EIA/IS-707-A standard (step A14). In this, the boundary value B using at the step A12, which is used to compare with the amount of the data storing in the buffer storage 31, is set to be a very small value, for example, a few Kbytes.

And the increasing/decreasing means 44 confirms that the operation decreasing the number of the forward traffic channels was completed (YES at step A15). And the operation decreasing the number of the forward traffic channels ends. When the end of the operation decreasing the forward traffic channels was confirmed, the decreased and remaining number of the forward traffic channels is used for transmitting the data. As mentioned above, the number of the forward traffic channels from the MS 3 to the BS 2 was decreased, and the number of the forward traffic channels being usable between the BS 2 and the other MSs was increased. Therefore, the transmission efficiency between the BS 2 and the other MSs can be made to be high.

At this operation decreasing the number of the forward traffic channels, when the amount of the data storing in the buffer storage 31 is less than the boundary value B, the case that the existing number of the forward traffic channels was decreased by half was explained. However, the number of the forward traffic channels can be decreased to one third or one fourth of the original using number of the forward traffic channels.

At the embodiment of the present invention, it was explained that the case that the number of the radio channels using at the transmission of the non-voice data was increased or decreased. However, the transmission efficiency of data can be also made to be high by increasing/decreasing the number of radio channels using at the other functions and/or by increasing/decreasing the frequency bands.

As mentioned above, according to the present invention, the amount of data storing in buffer storage in a base station or the amount of data storing in buffer storage in a mobile station is measured. And this storing amount is compared with a first threshold value and a second threshold value. And based on the compared result, the number of the forward traffic channels or the number of the reverse traffic channels is increased or decreased by the compared results with the first threshold value or the second threshold value. With this, the number of the forward traffic channels or the number of the reverse traffic channels using between the base station and the mobile station is increased or decreased, therefore, non-voice data can be transmitted/received efficiently.

While the present invention has been described with reference to the particular illustrative embodiment, it is not to be restricted by that embodiment but only by the appended claims. It is to be appreciated that those skilled in the art can change or modify the embodiment without departing from the scope and spirit of the present invention.

What is claimed is:

1. A radio communication system, comprising:
plural base stations;
plural mobile stations; and
plural controllers for controlling the number of radio channels,
wherein:
said base station, comprising:
a first deciding means for deciding the number of reverse traffic channels being radio channels that is used when said base station transmits data to said mobile station;
first buffer storage for storing said data temporarily; and
a first data transmitting means for transmitting said data storing in said first buffer storage to said mobile station by using the number of said reverse traffic channels decided at said first deciding means, and
said mobile station, comprising:
a second deciding means for deciding the number of forward traffic channels being radio channels that is used when said mobile station transmits data to said base station;
second buffer storage for storing said data temporarily; and
a second data transmitting means for transmitting said data storing in said second buffer storage to said base station by using the number of said forward traffic channels decided at said second deciding means, and
said controller, comprising:
a first measuring means for measuring the amount of said data storing in said first buffer storage;
a second measuring means for measuring the amount of said data storing in said second buffer storage;
a first comparing means for comparing the amount of said data measured at said first measuring means with a first threshold value and a second threshold value;
a second comparing means for comparing the amount of said data measured at said second measuring means with said first threshold value and said second threshold value;
a first increasing/decreasing means for increasing the number of said reverse traffic channels when the amount of said data storing in said first buffer storage is more than said first threshold value and for decreasing the number of said reverse traffic channels when the amount of said data storing in said first buffer storage is less than said second threshold value based on said compared result at said first comparing means; and
a second increasing/decreasing means for increasing the number of said forward traffic channels when the amount of said data storing in said second buffer storage is more than said first threshold value and for decreasing the number of said forward traffic channels when the amount of said data storing in said second buffer storage is less than said second threshold value based on said compared result at said second comparing means.

2. A radio communication system in accordance with claim 1, wherein:
said controller, further comprising:
a timer for setting timing of measuring said amount of said data storing in said first buffer storage or in said second buffer storage by said first measuring means or said second measuring means.

3. A radio communication system in accordance with claim 1, wherein:
said controller is built in said mobile station or said base station.

4. A radio communication system in accordance with claim 1, wherein:
one number of said reverse traffic channels is increased every when the amount of said data storing in said first buffer storage exceeds one said first threshold value, and one number of said forward traffic channels is increased every when the amount of said data storing in said second buffer storage exceeds one said first threshold value.

5. A radio communication system in accordance with claim 1, wherein:
the number of said reverse traffic channels or said forward traffic channels is decreased by half or to one third, or to one fourth, and when the number of said reverse traffic channels or said forward traffic channels was decreased too many, the number is increased again.

6. A radio communication system in accordance with claim 1, wherein:
the number of said radio channels including the increased number of said radio channels by said first or second increasing/decreasing means does not exceed the maximum number of said reverse traffic channels or said forward traffic channels that was confirmed to be able to use between said base station and said mobile station each other at the time when communication was started.

7. A base station in a radio communication system, comprising:
a deciding means for deciding the number of radio channels that is used when said base station transmits data to a mobile station;
buffer storage for storing said data temporarily;
a data transmitting means for transmitting said data storing in said buffer storage to said mobile station by using the number of said radio channels decided at said deciding means; and
a controller for controlling the number of said radio channels, wherein: said controller, comprising:
a measuring means for measuring the amount of said data storing in said buffer storage;
a comparing means for comparing the amount of said data measured at said measuring means with a first threshold value and a second threshold value; and
an increasing/decreasing means for increasing the number of said radio channels when the amount of said data storing in said buffer storage is more than said first threshold value and for decreasing the number of said radio channels when the amount of said data storing in said buffer storage is less than said second threshold value based on said compared result at said comparing means.

8. A mobile station in a radio communication system, comprising:
a deciding means for deciding the number of radio channels that is used when said mobile station transmits data to a base station;
buffer storage for storing said data temporarily;
a data transmitting means for transmitting said data storing in said buffer storage to said base station by using the number of said radio channels decided at said deciding means; and
a controller for controlling the number of said radio channels, wherein: said controller, comprising:
a measuring means for measuring the amount of said data storing in said buffer storage;
a comparing means for comparing the amount of said data measured at said measuring means with a first threshold value and a second threshold value; and
an increasing/decreasing means for increasing the number of said radio channels when the amount of said data storing in said buffer storage is more than said first threshold value and for decreasing the number of said radio channels when the amount of said data storing in said buffer storage is less than said second threshold value based on said compared result at said comparing means.
